(19) United States
(12) Patent Application Publication
(10) Pub. No.: US 2022/0002466 A1
(43) Pub. Date: Jan. 6, 2022

(54) POLYMERS

(71) Applicant: Imperial College of Science, Technology and Medicine, London (GB)

(72) Inventors: Theonitsa GEORGIOU, London (GB); Anna CONSTANTINOU, London (GB)

(21) Appl. No.: 17/278,771

(22) PCT Filed: Sep. 24, 2019
(86) PCT No.: PCT/GB2019/052686

§ 371 Date: Mar. 23, 2021

(30) Foreign Application Priority Data
Sep. 24, 2018 (GB) 1815523.4

(51) Int. Cl. C08F 293/00; C08F 220/18; C08F 220/28; C08F 2/38

(52) U.S. Cl. CPC C08F 293/005; C08F 220/1804; C08F 2438/03; C08F 2/38; C08F 2438/01; C08F 220/286

(57) ABSTRACT

A block copolymer comprising at least three polymer blocks, block A, block B and block C, wherein block A comprises polymerised monomer A′ or polymerised monomers A′ and C′; block B comprises polymerised monomer B′; and block C comprises polymerised monomer C′ or polymerised monomers A′ and C′; wherein monomers A′, B′ and C′ are defined herein.

### FIELD OF INVENTION

The invention relates to amphiphilic block copolymers and methods of production thereof.

### BACKGROUND

Amphiphilic copolymers (i.e. polymers that contain both hydrophilic and hydrophobic components) have a vast variety of applications: bioapplications such as drug delivery, tissue engineering, as emulsifiers and de-emulsifiers in a number of industries like oil and gas, and in the formulation industry (pharmaceutical and fast-moving consumer goods).

A well-known amphiphilic family of polymers is the Pluronic Family® (U.S. Pat. No. 5,256,396). These are ABA triblock copolymers based on poly(ethylene glycol) (A block) and poly(propylene glycol) (B block), also named as poly(ethylene oxide) (A) and poly(propylene oxide) (B), respectively. Pluronic® polymers have been used as thickening or gelling agents in the pharmaceutical industry, for example as a wound barrier for pain relieve (T. Beynon et al, J. Pain Symptom Manage., 2003, 26, 776-780). Pluronic® polymers are also used as stabilisers, defoaming agents, binders, and as gelling agents in cosmetics, medicine, agriculture, and the textile and food industry.

It is desirable to provide additional amphiphilic copolymers, for example for use as gelling agents.

### SUMMARY OF THE INVENTION

In a first aspect, the disclosure provides a block copolymer comprising at least three polymer blocks, block A, block B and block C, wherein block A comprises polymerised monomer A′ or polymerised monomers A′ and C′; block B comprises polymerised monomer B′; and block C comprises polymerised monomer C′ or polymerised monomers A′ and C′:

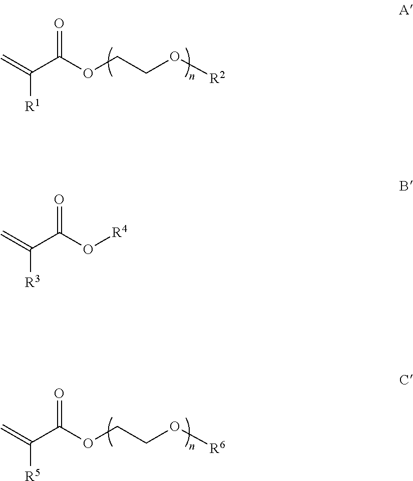

wherein each of R¹, R³, and R⁵ is independently selected from hydrogen and methyl; each of R² and R⁶ is independently selected from hydrogen and C₁-C₃ alkyl; R⁴ is C₁-C₁₄ alkyl; and n is an integer of at least 3.

In a second aspect, the disclosure provides a thermoresponsive gel composition comprising a block copolymer as disclosed herein and an aqueous solvent.

In a third aspect, the disclosure provides a method for preparing a block copolymer as disclosed herein by group transfer polymerisation, comprising the step of: sequentially polymerising monomers A′, B′ and C′, in any order, in the presence of an initiator and a catalyst to form a block copolymer.

### DESCRIPTION OF THE FIGURES

FIGS. 1a to 1d show phase diagrams of copolymers in phosphate buffered saline (PBS).

FIG. 2 shows rheological curves of 15 w/w % solutions of block copolymers in PBS.

### DETAILED DESCRIPTION OF THE INVENTION

The present disclosure relates to block copolymers comprising at least three blocks, derived from acrylate or methacrylate monomers, or a combination thereof. The block copolymers disclosed herein are amphiphilic, comprising hydrophobic and hydrophilic blocks.

Accordingly, in a first aspect, the disclosure provides a block copolymer comprising at least three polymer blocks, block A, block B and block C, wherein block A comprises polymerised monomer A′ or polymerised monomers A′ and C′; block B comprises polymerised monomer B′; and block C comprises polymerised monomer C′ or polymerised monomers A′ and C′:

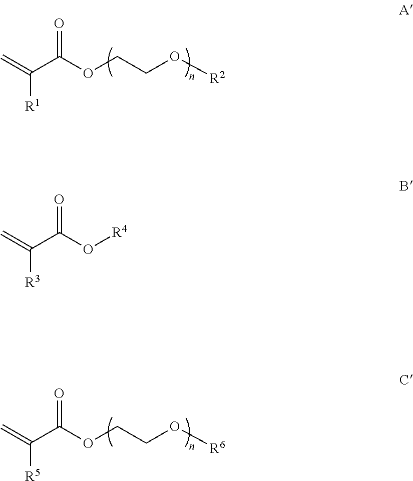

wherein each of R¹, R³, and R⁵ is independently selected from hydrogen and methyl; each of R² and R⁶ is independently selected from hydrogen and C₁-C₃ alkyl; R⁴ is C₁-C₁₄ alkyl; and n is an integer of at least 3.

Polymerised monomers A′, B′ and C′ have the following structures:

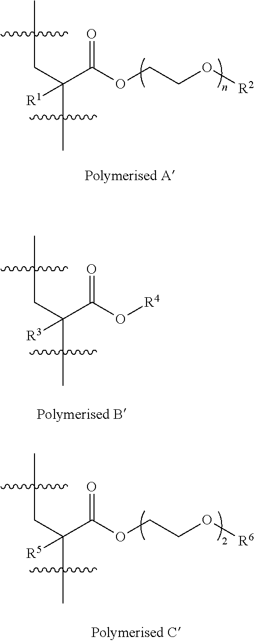

For monomers A′, B′, and C′, each of R¹, R³, and R⁵ is independently selected from hydrogen and methyl. R¹, R³, and R⁵ may, for example, each independently be methyl. Each of R² and R⁶ is independently selected from hydrogen and C₁-C₃ alkyl. R² and R⁶ may, for example, each independently be methyl or ethyl. R⁴ is C₁-C₁₄ alkyl. R⁴ may, for example, be C₁-C₁₂, C₁-C₈ or C₃-C₆ alkyl. For example, R⁴ may be n-butyl. n is an integer of at least 3. n may, for example, be an integer from 3 to 12. For example, n may be from 3 to 9, from 3 to 7 or from 4 to 6. n may be 5.

Accordingly, monomer A′ is a poly(ethylene glycol) derived acrylate or methacrylate (i.e. R¹ is H or methyl, R² is H or C₁-C₃ alkyl and n is at least 3). n may be an integer from 3 to 12. For example, n may be from 3 to 12, from 3 to 9, from 3 to 7, from 4 to 6 or 5. Monomer A′ may be penta(ethylene glycol) methyl ether methacrylate (i.e. R¹ is methyl, R² is methyl and n is 5).

Monomer B′ is a C₁-C₁₄ alkyl acrylate or C₁-C₁₄ alkyl methacrylate (i.e. R³ is H or methyl and R⁴ is C₁-C₁₄ alkyl). Monomer B′ may be a C₁-C₁₂, C₁-C₈ or C₃-C₆ alkyl alkyl acrylate or methacrylate. For example, B′ may be n-butyl methacrylate (i.e. R³ is methyl and R⁴ is n-butyl).

Monomer C′ is a di(ethylene glycol) derived acrylate or methacrylate (i.e. R⁵ is H or methyl and R⁶ is H or C₁-C₃ alkyl). Monomer C′ may be a di(ethylene glycol) methyl ether methacrylate (i.e. R₅ is methyl and R₆ is methyl).

A block copolymer disclosed herein may, for example, be a block copolymer wherein block A is poly(penta(ethylene glycol) methyl ether methacrylate) (poly(PEGMA)), block B is poly(n-butyl methacrylate) (poly(BuMA)), and block C is poly(di(ethylene glycol) methyl ether methacrylate) (poly(DEGMA)). For example, the polymer may be poly(PEGMA)-b-poly(BuMA)-b-poly(DEGMA).

Each of blocks A, B, and C may, for example, independently comprise a homopolymer of monomer A′, B′ and C′, respectively. An additional monomer may be present in one or more of blocks A, B and C. For example, one or more of blocks A, B, or C may be a copolymer (for example a random copolymer) of monomer A′, B′, or C′, respectively, and at least one additional monomer (e.g. any acrylate or methacrylate).

Accordingly, block A may, for example, comprise a homopolymer block of polymerised monomer A′, a copolymer (e.g. a random copolymer) block of polymerised monomers A′ and C′ or a copolymer (e.g. a random copolymer) block of two different polymerised A′ monomers. Block B may, for example, comprise a homopolymer block of polymerised monomer B′ or a copolymer (e.g. a random copolymer) block of two different polymerised B′ monomers. Block C may, for example, comprise a homopolymer block of polymerised monomer C′ or a copolymer (e.g. a random copolymer) block of polymerised monomers A′ and C′. Block C may be a copolymer (e.g. a random copolymer) block of two different polymerised C′ monomers.

For example, the block copolymer disclosed herein may be a block copolymer comprising at least three polymer blocks, block A, block B and block C, wherein block A is a homopolymer of monomer A′ or a random copolymer of monomers A′ and C′; block B is a homopolymer of monomer B′; and block C is a homopolymer of monomer C′ or a random copolymer of monomers A′ and C′. For example, the block copolymer may be poly(PEGMA-ran-DEGMA)-b-poly(BuMA)-b-poly(PEGMA-ran-DEGMA).

The block copolymer may, for example, comprise 10 w/w % to 80 w/w % of each of polymerised monomers, wherein the w/w % of each monomer is expressed as a proportion of the total polymerised monomer A′, monomer B′ and monomer C′ content of the block copolymer. The block copolymer may comprise at least about 15, 20, 25, 30, 35, or 40 w/w % of polymerised monomer A′, at least about 15, 20, 25, or 30 w/w % of polymerised monomer B′, and/or at least about 10, 15, 20, or 25 w/w % of polymerised monomer C′.

The block copolymer may, for example, comprise at most about 60, 55, 50, or 45 w/w % of polymerised monomer A′, at most about 50, 45, 40, or 35 w/w % of polymerised monomer B′, and/or at most about 40, 35, 30, or 25 w/w % of polymerised monomer C′, wherein the w/w % of each monomer is expressed as a proportion of the total polymerised monomer A′, monomer B′ and monomer C′ content of the block copolymer.

The block copolymer may, for example, comprise about 30 to about 55 w/w % of polymerised monomer A′, about 25 to about 40 w/w % of polymerised monomer B′, and/or about 15 to about 40 w/w % of polymerised monomer C′ as a proportion of the total polymerised monomer A′, monomer B′ and monomer C′ content of the block copolymer.

For example, the w/w % of polymerised monomer A′ may be about 36 to about 46 w/w % and/or the w/w % of polymerised monomer B′ may be about 29 to about 39 w/w % and/or the w/w % of polymerised monomer C′ may be about 20 to about 30 w/w %. The w/w % of polymerised monomer A′ may be about 39 to about 43 w/w % and/or the w/w % of polymerised monomer B′ may be about 32 to about 36 w/w % and/or the w/w % of polymerised monomer C′ may be about 23 to about 27 w/w %. The w/w % of polymerised monomer A′ may be about 41 w/w % and/or the w/w % of polymerised monomer B′ may be about 34 w/w % and/or the w/w % of polymerised monomer C′ may be about 25 w/w %.

The block copolymer may, for example, comprise 10 mol % to 80 mol % of each of polymerised monomer A′, monomer B′ and monomer C′, wherein the mol % of each monomer is expressed as a proportion of the total polymerised monomer A′, monomer B′ and monomer C′ content of the block copolymer. The block copolymer may comprise at least about 10, 15, 20, or 25 mol % of polymerised monomer A′, at least about 20, 25, 30, 35, 40, or 45 mol % of polymerised monomer B′, and/or at least about 10, 15, 20, 25, 30, or 35 mol % of polymerised monomer C′.

The block copolymer may, for example, comprise at most about 50, 45, 40, 35, or 30 mol % of polymerised monomer A′, at most about 65, 60, 55, or 50 mol % of polymerised monomer B′, and/or at most about 45, 40, 35, or 30 mol % of polymerised monomer C′, wherein the mol % of each monomer is expressed as a proportion of the total polymerised monomer A′, monomer B′ and monomer C′ content of the block copolymer.

For example, the mol % of polymerised monomer A′ may be about 15 mol % to about 40 mol % and/or the mol % of polymerised monomer B′ may be about 35 mol % to about 55 mol % and/or the mol % of polymerised monomer C′ may be about 20 mol % to about 45 mol %. The mol % of polymerised monomer A′ may be about 22 mol % to about 32 mol % and/or the mol % of polymerised monomer B′ may be about 42 mol % to about 52 mol % and/or the mol % of polymerised monomer C′ may be about 20 mol % to about 30 mol %. The mol % of polymerised monomer A′ may be about 25 mol % to about 30 mol % and/or the mol % of polymerised monomer B′ may be about 45 mol % to about 50 mol % and/or the mol % of polymerised monomer C′ may be about 23 mol % to about 28 mol %. The mol % of polymerised monomer A′ may be about 27 mol % and/or the mol % of polymerised monomer B′ may be about 47 mol % and/or the mol % of polymerised monomer C′ may be about 26 mol %.

The mol % and w/w % content of each of the polymerised monomers can be determined using ¹H NMR spectroscopy. The mol % and w/w % values recited herein correspond to the proportion of one polymerised monomer (A′, B′ or C′) in relation to the total content (molar or weight, respectively) of polymerised monomers A′, B′ and C′ present in the block copolymer.

The block copolymer may, for example, have a narrow molar mass distribution (MMD). For example, the dispersity index (D) may be 2.0 or less, 1.5 or less, 1.4 or less, 1.3 or less, or 1.2 or less.

“Molar mass distribution” (MMD) refers to the breadth of the molar mass and degree of polymerisation for the individual polymer molecules. This may be measured by the dispersity index (Ð), which is calculated by dividing weight average molar mass by number average molar mass (M_{w}/Mₙ).

The block copolymer may, for example, have a number average molar mass (Mₙ) of about 1 to about 100 kDa. The block copolymer may have an Mₙ of about 1 to about 50 kDa, for example about 5 to about 25 kDa. The polymer may have an Mₙ of about 5 to about 20 kDa.

Values for molar mass distribution, number average molar mass and weight average molar mass of the polymers may be measured using Gel Permeation Chromatography (GPC).

The block copolymer may, for example, be formed by the polymerisation of monomers A′, B′ and C′, wherein 10 mol % to 80 mol % of each of polymerised monomers A′, B′ and C′ are introduced into the polymerisation reaction as a proportion of the total monomer A′, monomer B′ and monomer C′ introduced. For example, at least about 10, 15, 20, 25, 30, or 35 mol % of monomer A′, at least about 20, 25, 30, 35, 40, or 45 mol % of monomer B′, and/or at least about 10, 15, 20, 25, 30, or 35 mol % of monomer C′ may be introduced into the polymerisation reaction as a proportion of the total monomer A′, monomer B′ and monomer C′ introduced.

The block copolymer may, for example, be formed by the polymerisation of monomers A′, B′ and C′, wherein at most about 50, 45, 40, 35, or 30 mol % of monomer A′, at most about 65, 60, 55, or 50 mol % of monomer B′, and/or at most about 45, 40, 35, or 30 mol % of monomer C′ is introduced into the polymerisation reaction as a proportion of the total monomer A′, monomer B′ and monomer C′ introduced.

For example, the mol % of monomer A′ introduced into the polymerisation reaction may be about 15 mol % to about 40 mol % and/or the mol % of monomer B′ introduced into the polymerisation reaction may be about 35 mol % to about 55 mol % and/or the mol % of monomer C′ introduced into the polymerisation reaction may be about 20 mol % to about 45 mol %. For example, the mol % of monomer A′ introduced into the polymerisation reaction may be about 20 mol % to about 30 mol % and/or the mol % of monomer B′ introduced into the polymerisation reaction may be about 45 mol % to about 55 mol % and/or the mol % of monomer C′ introduced into the polymerisation reaction may be about 20 mol % to about 30 mol %. The mol % of monomer A′ introduced into the polymerisation reaction may be about 25 mol % and/or the mol % of monomer B′ introduced into the polymerisation reaction may be about 50 mol % and/or the mol % of monomer C′ introduced into the polymerisation reaction may be about 25 mol %.

The block copolymer may comprise blocks A, B and C arranged according to formula (I), (II) or (III):

-A-B-C- (I)

-B-A-C- (II)

-A-C-B- (III)

For example, the block copolymer may be a triblock copolymer of the formula (Ia), (IIa) or (IIIa):

*-A-B-C-* (Ia)

*-B-A-C-* (IIa)

*-A-C-B-* (IIIa)

with termination of the polymer at the position marked *. A skilled person will appreciate that termination may be with any suitable moiety such that a stable polymer is formed. The polymer may, for example, be terminated with hydrogen, hydroxyl, amine, a lactone functional group or a group derived from a polymerisation initiator (I′), such that a stable polymer is formed. For example, the block copolymer may be terminated at one end by a group derived from I′ or a moiety that contains a hydroxyl, amine, or a lactone and/or terminated at the other end by hydrogen. Termination with moieties comprising hydroxyl, amine, and lactone functional groups may be achieved, for example, by reacting the initiator derived group with a moiety comprising a hydroxyl, amine, or lactone functional group. Suitable functional groups for termination of the block copolymers are provided in Gnaneshwar et al, J. Polym. Sci., Part A: Polym. Chem., 2007, 46, 2514-2531, the contents of which are hereby incorporated by reference.

The block copolymer may, for example, further comprise one or more polymeric groups or other additional components, in addition to blocks A, B, and C. For example, the block copolymer may comprise a further A, B, or C block (e.g. a tetrablock copolymer of formula B-A-B-C, A-B-C-A or A-C-B-C). The block copolymer may additionally comprise a different polymeric component, such as a peptide.

It will be appreciated that block A, B and/or C may be directly or indirectly linked. For example, the block copolymer may comprise linker groups and/or additional polymeric groups between blocks A, B and C.

Each of blocks A, B, and C of the block copolymer disclosed herein may, for example, comprise at least 5, 6, 7, 8, 9, or 10 monomeric repeat units. Each of blocks A, B, and C may, for example, comprise at most 200, 150, 100, 50, 30, or 25 monomeric repeat units. For example, block A may consist of 5 to 20, optionally 8 to 14, optionally 11 repeat units of monomer A′ or monomers A′ and C′, block B may consist of 10 to 30, optionally 17 to 23, optionally 20 monomeric repeat units of monomer B′, and/or block C may consist of 5 to 25, optionally 9 to 17, optionally 11 monomeric repeat units of monomer C′ or monomers A′ and C′.

The block copolymer may, for example, be water soluble at room temperature (25° C.). For example, at room temperature the polymer may be soluble in water at concentrations of 50, 25, 20, 15, 10, or 5 w/w % or below.

The block copolymer may, for example, form a gel in an aqueous solvent (e.g. phosphate buffered saline). For example, the block copolymer may form a gel at a concentration of 30 w/w % in phosphate buffered saline (PBS). The block copolymer may form a gel at a concentration of 25, 20, 15, 10, 5, 2 or 1 w/w % in PBS. The block copolymer may form a gel at a temperature of 20° C. or above, 25° C. or above, 30° C. or above, or 35° C. or above.

The block copolymer forms a gel if it exhibits a transition from a solution phase to a gel phase in aqueous solvent (e.g. PBS). Formation of a gel by a block copolymer disclosed herein may be identified visually according to an inverted vial test. A vial containing a polymer sample in aqueous solvent (e.g. PBS) is inverted and observed. Gel formation is identified if the polymer sample does not visibly flow when the vial is inverted.

The block copolymer may, for example, be thermoresponsive. For example, the block copolymer may exhibit a solution-gel phase transition as a function of temperature. Accordingly, the inverted vial test may be carried out at a range of temperatures, increasing temperature until gel formation occurs. The “gel point” or “gelation point” is the temperature at which the solution-gel phase transition occurs, for example as observed by the polymer sample no longer visibly flowing when the vial is inverted.

Gel formation may also be identified rheologically. For example, a storage (elastic) modulus (G′) that is larger than the loss (viscous) modulus (G″) of a polymer sample is indicative of gel formation. The gel point of a block copolymer disclosed herein may be defined quantitatively according to a rheological test. The storage modulus and loss modulus of a polymer sample in aqueous solvent (e.g. PBS) are measured at a range of increasing temperatures (e.g. increasing from room temperature at 1° C. intervals). The gel point is the temperature at which the storage modulus first exceeds the loss modulus (Yu et al, Langmuir 1998, 14, 5782-5789).

The block copolymer may, for example, have a gelation point at a concentration of 30 w/w % in PBS of 20° C. or above. For example, the block copolymer may have gelation point at a concentration of 25, 20, 15, 10, 5, 2, or 1 w/w % in PBS of 20° C. or above, 25° C. or above, 30° C. or above, or 35° C. or above. The block copolymer may have gelation point at a concentration of 10 w/w % in PBS of 20° C. or above, 25° C. or above, or 30° C. or above.

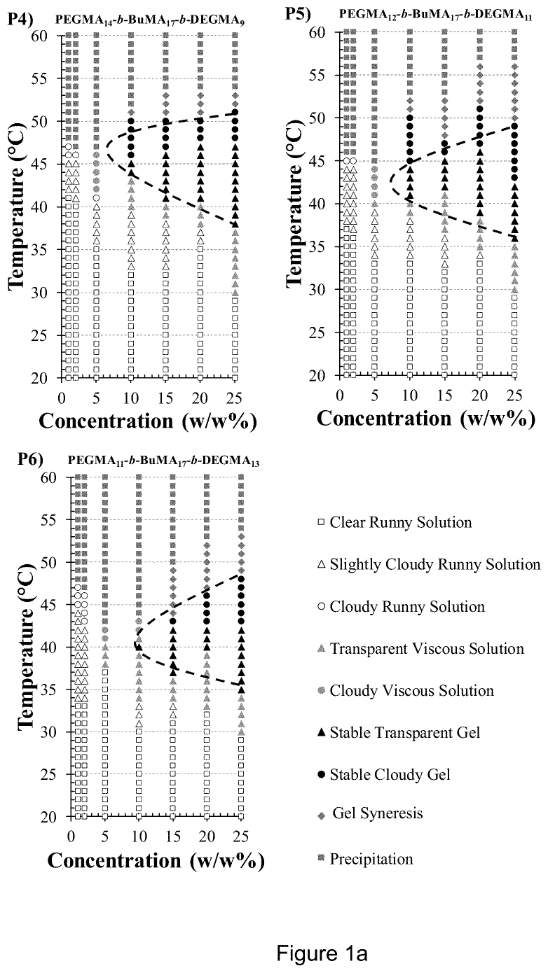

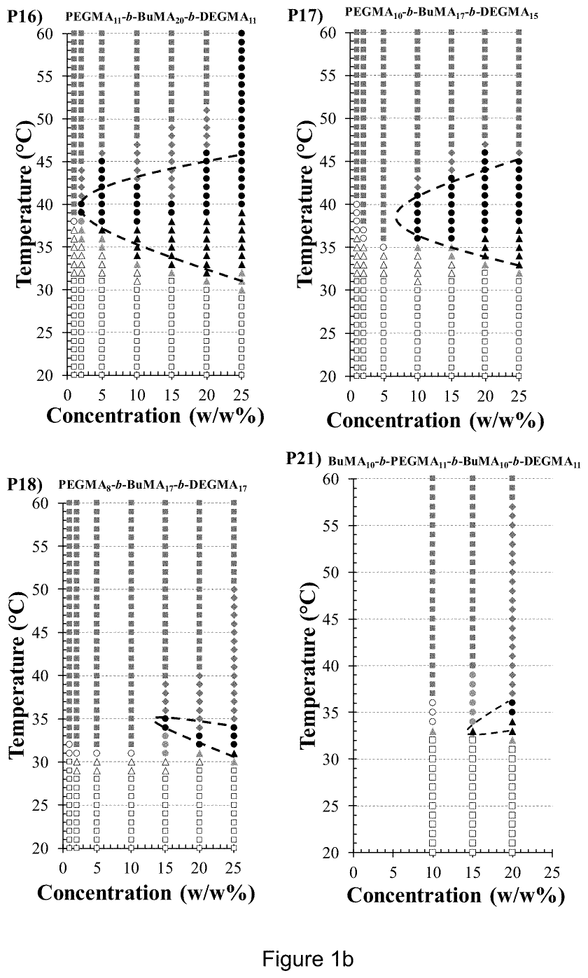

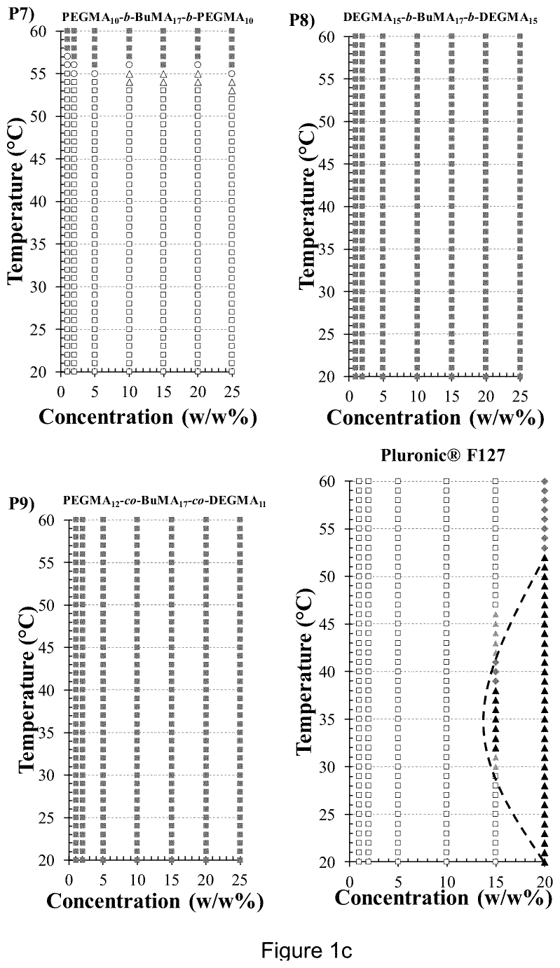

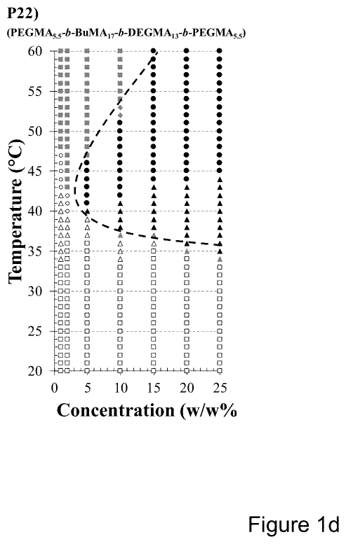

In a typical rheology graph for a gel-forming thermoresponsive polymer (such as those of FIGS. 1a and 1b), the viscosity as well as the storage and loss moduli increase while increasing the temperature, and when the temperature is close to the thermoresponsive point of the polymer both moduli and viscosity increase significantly.

In a second aspect, the disclosure provides a thermoresponsive gel composition comprising a block copolymer as disclosed herein and an aqueous solvent. For example, the aqueous solvent may be water or phosphate buffered saline.

The composition may, for example, further comprise one or more additional polymers.

### Applications of Polymers of the Invention

A block copolymer as disclosed herein may, for example, act as a gelling agent, either as a single agent or in admixture with one or more additional polymers.

A block copolymer as disclosed herein may, for example, be used in a method of drug delivery. The block copolymer may be useful in methods for sustained drug release. For example, a composition according to the second aspect may be provided, further comprising a therapeutic agent. The composition may result in sustained release of the therapeutic agent. The composition may be suitable for use in therapy.

A block copolymer as disclosed herein may, for example, be used for tissue engineering, for example to replace damaged tissue. A solution of the block copolymer may be mixed with cells at room temperature and injected into a patient. In situ, due to the temperature increase (body temperature 37° C.), the polymer may form a gel. The cells encapsulated within the gel then proliferate to replace damaged tissue in vivo.

A block copolymer as disclosed herein may, for example, be attached (e.g. covalently bonded) to a biological entity, for example, a peptide, protein or enzyme.

A block copolymer as disclosed herein may, for example, be used as a dispersant and/or emulsifier. For example, the block copolymer may be used to stabilise particles in solution or to stabilise emulsions.

A block copolymer as disclosed herein may, for example, be used as a thickening agent, a binding agent or a defoaming agent to reduce the formation of foam in a liquid.

A block copolymer as disclosed herein may, for example, be used in 3-D and injection printing at various temperatures. For example, to the block copolymer may be used to print bio-ink for tissue engineering applications.

### Polymer Synthesis

The disclosed block copolymers can be synthesized by conventional methods, for example anionic polymerisation or living radical polymerisations (e.g. group transfer polymerisation, atom transfer radical polymerisation (ATRP) or reversible addition fragmentation chain transfer (RAFT) polymerisation). Synthesis may be performed using group transfer polymerisation (GTP). GTP is performed at room temperature and at higher concentrations than most other polymerisation methods, and can be performed in one pot, making it more cost-effective than other polymerisation methods. Furthermore, GTP is living polymerisation technique so can produce polymers of narrow molar mass distribution and defined molar mass and composition.

Accordingly, in a third aspect, the disclosure provides a method for preparing a block copolymer as disclosed herein by group transfer polymerisation, comprising the step of: sequentially polymerising monomers A′, B′ and C′, in any order, in the presence of an initiator and a catalyst to form a block copolymer.

The initiator may be any initiator suitable for use in GTP. The initiator may, for example, be a silyl ketene acetyl such as 1-methoxy-1-trimethylsiloxy-2-methyl propene (MTS). The initiator may be Me₃SiCN, Me₃SiSR, or (RO)₂POSiMe₃ (wherein R is alkyl).

The catalyst may be any catalyst suitable for use in GTP. The catalyst may, for example, be a nucleophilic anion, such as trisdimethylaminosulfonium (TAS) bifluoride, tetrabutyl ammonium bibenzoate (TBABB), bis(triphenylphosphoranylidene)ammonium bifluoride or potassium 18-crown-6. The catalyst may be a nucleophilic anion, such as ZnCl₂, ZnCl₂, R₂AlCl (wherein R is alkyl), or HgCl₂ activated by TMS iodine. For example, the catalyst may be tetrabutyl ammonium bibenzoate (TBABB).

Further initiators, catalysts and conditions suitable for preparing the block copolymers disclosed herein are provided in Webster, Adv. Poly. Sci., 2004, 167, 1-34 and Fuchise et al, Polym. Chem., 2013, 4, 4278-4291; the contents of which are hereby incorporated by reference.

The method may further comprise the step of isolating the formed block copolymer.

When monomer A′ comprises an OH-terminated poly(ethylene glycol) and/or monomer C′ comprises an OH-terminated di(ethylene glycol) (i.e. R² and/or R⁶ are hydrogen), the OH group of the monomer may be protected prior to polymerisation and deprotected once the polymerisation is complete. Suitable OH protecting groups may be found in Greene's Protective Groups in Organic Synthesis, Fourth Edn, the contents of which are hereby incorporated by reference.

All of the features of the copolymers disclosed in this specification may be combined in any combination, except combinations where at least some of such features and/or steps are mutually exclusive. Moreover, features described herein in relation to the first aspect of the disclosure apply mutatis mutandis to the second and third aspects of the disclosure. Likewise, features described in non-essential combinations may be used separately (not in combination).

As used herein, an alkyl group is a straight chain or branched group.

The term “polymer” refers to a macromolecule formed by polymerisation of repeated monomer subunits. For example, a polymer may comprise at least 5, 10, 15, 20, 25 or 30 monomeric subunits. The term “homopolymer” refers to a polymer derived from a single monomer. The term “copolymer” refers to a polymer derived from more than one species of monomer. The term “random copolymer” refers to a copolymer in which the monomer subunits are located randomly in the polymer molecule. A random sequence arrangement of monomeric subunits may be represented by, for example, poly(A′-ran-B′-ran-C′), where -ran-indicates a random sequence distribution with regard to A′, B′, and C′ monomeric subunits.

The term “block copolymer” as used herein refers to a copolymer that comprises three or more distinct polymeric blocks. A block copolymer may be represented by, for example, poly(A′)-b-poly(B′)-b-poly(C′), where -b- indicates that the polymerised monomer subunits A′, B′ and C′ each form a separate block. In the context used herein, each block be a homopolymer or a copolymer (e.g. a random copolymer). Each block may have at least 5 monomeric repeat units. In a block copolymer as disclosed herein, the blocks may be directly linked or may contain linker portions between two or more blocks.

The term “triblock terpolymer” as used herein refers to a block copolymer containing three polymeric blocks, wherein each block consists of a different polymer (e.g. A-B-C).

The term “triblock dipolymer” as used herein refers to a block copolymer containing three polymeric blocks, wherein two of the blocks contain the same polymer (e.g. A-B-A or C-B-C).

The term “about” is used herein to mean approximately, in the region of, roughly, or around. When the term “about” is used in conjunction with a numerical range, it modifies that range by extending to boundaries above and below the numerical range set forth. In general, the term “about” is used herein to modify a numerical value above and below the stated value by a variance of 10%.

Throughout the description and claims of this specification, the words “comprise” and “contain” and variations of the words, for example “comprising” and “comprises”, mean “including but not limited to”, and are not intended to (and do not) exclude other components. In any of the embodiments described herein, reference to “comprising” also encompasses “consisting essentially of” and “consisting of”.

The present disclosure will now be explained in more detail by reference to the following non-limiting examples.

### EXAMPLES

### Monomer Abbreviations

| | |
|---|---|
| PEGMA | penta(ethylene glycol) methyl ether methacrylate |
| BuMA | n-butyl methacrylate |
| DEGMA | di(ethylene glycol) methyl ether methacrylate |

### Example 1: Synthesis of Block Copolymers

Block copolymers were synthesised via sequential group transfer polymerisation. i.e. the monomers were added sequentially after the addition of the initiator, 1-methoxy-1-trimethylsiloxy-2-methyl propene (MTS).

P16 (Theoretical Polymer Structure PEGMA₁₁-b-BuMA₂₀-b-DEGMA₁₁)

In a 250 mL round-bottom flask, tetrabutyl ammonium bibenzoate (TBABB, catalyst, ˜20 mg) was added and the flask was then sealed with a rubber septum and purged with inert argon gas, to ensure an atmosphere-free environment. After this step, freshly-purified THF (60 mL) was syringed in the flask, followed by the addition of 0.55 mL of 1-methoxy-1-trimethylsiloxy-2-methyl propene (MTS) (0.47 g, 2.7 mmol). Then, the monomers were sequentially added as follows: i) 16.9 mL of penta(ethylene glycol) methyl ether methacrylate (PEGMA) solution in THF (50 vol %) (8.9 g, 29.6 mmol), ii) 8.7 mL of n-butyl methacrylate (BuMA, 7.8 g, 54.6 mmol), and iii) 5.4 mL of di(ethylene glycol) methyl ether methacrylate (DEGMA, 5.6 g, 29.5 mmol). After each addition, an exotherm was detected: i) from 26.9 to 36.9° C., ii) 30.9 to 40.8° C., and 32.9 to 37.1° C., respectively. After each monomer fully reacted, two samples of 0.1 mL were extracted for GPC and ¹H NMR analysis. The polymer was then precipitated in cool hexane.

The following block copolymers P4-8, P16-P18, P21 and P22 were also synthesised according to this procedure.

TABLE 1
Theoretical chemical structures of synthesised polymers.

| Polymer No. | Theoretical Polymer Structure |
|---|---|
| P4 | PEGMA₁₄-b-BuMA₁₇-b-DEGMA₉ |
| P5 | PEGMA₁₂-b-BuMA₁₇-b-DEGMA₁₁ |
| P6 | PEGMA₁₁-b-BuMA₁₇-b-DEGMA₁₃ |
| P7 | PEGMA₁₀-b-BuMA₁₇-b-PEGMA₁₀ |
| P8 | DEGMA₁₅-b-BuMA₁₇-b-DEGMA₁₅ |
| P9 | PEGMA₁₂-ran-BuMA₁₇-ran-DEGMA₁₁ |
| P16 | PEGMA₁₁-b-BuMA₂₀-b-DEGMA₁₁ |
| P17 | PEGMA₁₀-b-BuMA₁₇-b-DEGMA₁₅ |
| P18 | PEGMA₈-b-BuMA₁₇-b-DEGMA₁₇ |
| P21 | BuMA₁₀-b-PEGMA₁₁-b-BuMA₁₀-b-DEGMA₁₁ |
| P22 | PEGMA_{5.5}-b-BuMA₁₇-b-DEGMA₁₃-b-PEGMA_{5.5} |

The “theoretical polymer structure” gives the calculated degree of polymerisation for the synthesised polymer. For example, PEGMA₁₁-b-BuMA₂₀-b-DEGMA₁₁ refers to a theoretical polymer composition of 11 units of the PEGMA monomer, 20 units of the BuMA monomer and 11 units of the DEGMA monomer.

The “degree of polymerisation” refers to the number of units of a monomer present in the polymer.

Polymers P4-P6, P16-P18, P21 and P22 are block copolymers as disclosed herein. P7 and P8 are triblock ABA and CBC polymers respectively, provided for reference. P9 is a random copolymer, provided for reference.

### Example 2: Characterisation of Polymers Using Gel Permeation Chromatography (GPC)

All polymers and their precursors (i.e. the intermediate polymers formed during the polymerisation after a monomer had fully reacted) were characterised by GPC to determine their number average molar mass (Mₙ), weight average molar mass (M_{w}) and molar mass distribution (MMD, [symbol] ). The system used was an Agilent SECcurity GPC system, purchased from Agilent technologies UK Ltd., Shropshire, UK. This system is equipped with: i) a Polymer Standard Service (PSS) SDV analytical linear M column (SDA083005LIM), ii) an Agilent 1250 refractive index (RI) detector, and iii) a “1260 Iso” isocratic pump. The mobile phase (THF with 5 vol % Et₃N) was pumped with a flow rate of 1 mL min⁻¹. The results were based on a poly(methyl methacrylate) (PMMA) calibration curve (using PMMA standard samples of 2, 4, 8, 20, 50, and 100 kg mol⁻¹). The samples were filtered through PTFE 0.45 μm filters prior to the measurement.

TABLE 2
Theoretical and experimental molecular masses (Mₙ), dispersity
indices ( [symbol] ), and compositions of the polymers.

| | MM^{theor.} | Mₙ | | % w/w PEGMA-BuMA-DEGMA | |
|---|---|---|---|---|---|
| No. | (g mol⁻¹) | (g mol⁻¹) | [symbol] | Theoretical | ¹H NMR |
| P4 | 8300 | 10700 | 1.18 | 50-30-20 | 54-28-18 |
| P5 | 8300 | 12200 | 1.18 | 45-30-25 | 49-30-21 |
| P6 | 8300 | 11500 | 1.18 | 40-30-30 | 41-29-30 |
| P7 | 8300 | 11000 | 1.19 | 70-30-00 | 72-28-00 |
| P8 | 8300 | 12500 | 1.23 | 00-30-70 | 00-31-69 |
| P9 | 8300 | 11300 | 1.15 | 45-30-25 | 47-29-24 |
| P16 | 8300 | 10000 | 1.19 | 40-35-25 | 41-34-25 |
| P17 | 8300 | 10300 | 1.16 | 35-30-35 | 38-30-32 |
| P18 | 8300 | 9600 | 1.17 | 30-30-40 | 32-30-38 |
| P21 | 8300 | 10690 | 1.14 | 40-35-25 | 44-34-22 |
| P22 | 8300 | 11600 | 1.21 | 40-30-30 | 42-28-30 |

The theoretical molar mass (MM^{theor.}) was calculated as the sum of MM^{monomer}×DP_{repeated unit}; where MM and DP are the abbreviations of molar mass and degree of polymerisation, respectively. With group transfer polymerisation, a part of the initiator remains on the polymer chain and therefore contributes to the total MM. When the initiator is MTS, an MM of 100 g mol⁻¹ is added to the polymer chain.

Dispersity index ( [symbol] ) is a measure of the molar mass distribution of the copolymer. Mₙ is the number average molar mass of the copolymer. The values of Mₙ and Ð were determined by GPC, where the calibration was based on well-defined linear poly(methyl methacrylate) standard samples with MM equal to 2, 4, 8, 20, 50, and 100 kg mol⁻¹.

### Example 3: Characterisation of Polymers Using Proton Nuclear Magnetic Resonance (¹H NMR) Spectroscopy

Supplementary to the GPC measurements, the successful syntheses of all the final copolymers and their precursors (if any) were confirmed via ¹H NMR, which gives information on the chemical composition of each polymer. For this analysis, deuterated chloroform (CDCl₃) was used as the NMR solvent, and the experiment was performed using a 400-MHz Avance Bruker NMR spectrometer (Bruker, UK Ltd., Coventry, UK). The ¹H NMR spectra were analysed, and the experimental values of the chemical compositions of the polymers were calculated (mol % and w/w %). For these calculations, the following peaks were integrated: i) 3.35 ppm for both DEGMA and PEGMA—these are both EG-based methacrylate units, and thus their distinctive peak is the same (the peak corresponding to the three methoxy protons); and ii) 3.9 ppm for BuMA, corresponding to the two methylene protons closest to the ester bond. As the peaks of PEGMA and DEGMA appear at the same region, the integration of each peak was obtained using the NMR spectra of the polymeric intermediates and of the final copolymers. For example, for P16 the relevant NMR spectra were for the diblock intermediate poly(PEGMA)-b-poly(BuMA), and the final triblock copolymer, poly(PEGMA)-b-poly(BuMA)-b-poly(DEGMA). In this case, the integration of the peak corresponding to DEGMA was calculated by subtracting the integration of the PEGMA peak (obtained from the diblock NMR spectrum) from the total integration of the PEGMA and DEGMA peaks (obtained from the triblock NMR spectrum). The integration ratios correspond to the mol % of each monomer. w/w % can then be calculated from the mol %, using the molecular weight of each monomer.

### Example 4: Visual Observation of Thermoresponsive Behaviour

### Cloud Point (CP)

The CP values of 1 w/w % polymer solutions in DI water were visually investigated. For this experiment, 3 mL vials containing the polymer solutions (˜2 mL) were immersed in a water-bath, which was heated up to different temperatures by using an IKA RCT stirrer hotplate, and an IKA ETS-D5 temperature controller. The CP was determined as the temperature at which the solution turned cloudy. 1 w/w % polymer solution of the Pluronic® F127 in DI water was also tested for CP.

### Visual Gel Point

The polymer solutions in PBS were tested visually for gelation, using the same equipment as was used for cloud point. The gel point is determined as the temperature at which the polymer sample no longer visibly flows when the vial is inverted. For the visual determination, the sample was left for two minutes once it had reached the desired temperature and then inverted. Different concentrations were investigated over a temperature range from 20 to 80° C., with a heating step of 1° C., and thus phase diagrams were plotted. On these phase diagrams, detailed transitions were included which are shown in FIGS. 1a to 1d. These transitions are runny solution (transparent, slightly cloudy, or cloudy), viscous solution (transparent or cloudy), stable gel (transparent or cloudy), and two-phased system (gel syneresis or precipitation).

Gel syneresis refers to a two-phased system comprising a gel phase and a solution phase. Precipitation refers to a two-phased system comprising a solid phase and a solution phase.

The gelation was investigated at various concentrations. Solutions of the Pluronic® F127 and P16 were also investigated for gelation in both DI water and PBS at various concentrations. Pluronic® F127 is a commercially available triblock dipolymer of the formula poly(ethylene glycol)-b-poly(propylene glycol)-b-poly(ethylene glycol).

Phase diagrams of copolymers in phosphate buffered saline (PBS) are depicted in FIG. 1a-d. The phases at each temperature and concentration are identified in the legend to FIG. 1a. The gelation region is approximately shown with a dashed line—this depicts the temperatures and concentrations at which the copolymers are in the gel phase.

ABC triblock terpolymers (P4-P6, and P16-P18) of the structure poly(PEGMA)-b-poly(BuMA)-b-poly(DEGMA) all formed gels at concentrations of 15 w/w % and higher. Notably, P16 formed a gel at a concentration of 1 w/w % in PBS. Tetrablock terpolymer P21 with blocks arranged as BABC also formed a gel at concentrations of 15 w/w % and higher. Tetrablock terpolymer P22 with blocks arranged as ABCA formed gels at a wider range of concentrations, comparable to the best performing ABC triblock copolymer.

ABA triblock bipolymer (P7) and CBC triblock bipolymer (P8) were tested. P7 did not form a gel at the concentrations and temperatures tested, while P8 was not soluble at the concentrations and temperatures tested, so also did not form a gel.

A random copolymer comprising monomers A′, B′, and C′ (P9) was also tested. P9 did not form a gel at the concentrations and temperatures tested.

A phase diagram for Pluronic® F127 is also included. A number of the block copolymers tested forms gels at lower w/w % concentrations than the Pluronic® F127.

### Example 5: Rheological Measurements

15 w/w % solutions in PBS of the synthesised polymers and Pluronic® F127 were investigated in terms of their rheological properties by a TA Discovery HR-1 hybrid rheometer (TA Instruments UK, a division of Waters Ltd., Hertfordshire, UK). The rheometer is equipped with a 40 mm parallel Peltier steel plate (996921) and a solvent trap; the second is used to prevent solvent evaporation. The changes in shear storage modulus (elastic modulus, G′) and shear loss modulus (viscous modulus, G″) were investigated over a temperature range from 20 to 80° C., by performing temperature ramp measurements with a ramp rate of 1° C. min⁻¹. The measurements were performed at a strain of 1%, and angular frequency (denoted as ω) of 1 rad s⁻¹. A conditioning step was performed prior to the main measurement (temperature ramp) to ensure homogeneity of the sample. Provided the values of G′ and G″, the complex viscosity (η*) was calculation using the Equation 4.14: η*=[(G″/ω)2+(G′/ω)²]^{1/2}.

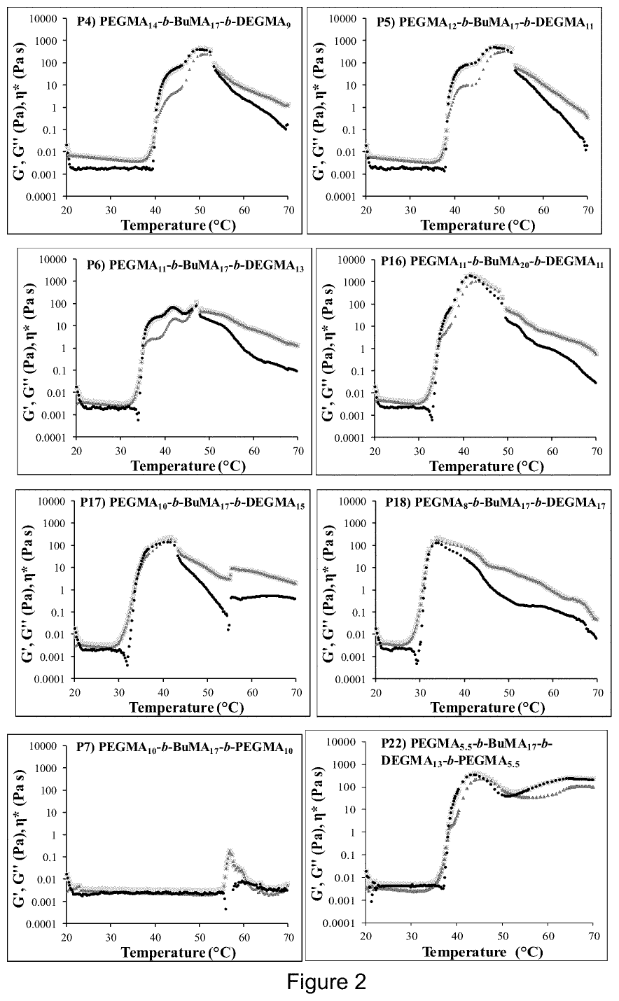

Rheological curves of 15 w/w % solutions of the ABC triblock terpolymers (P4-P6, and P16-P18), the ABA triblock bipolymer (P7), and the ABCA tetrablock terpolymer (P22) in phosphate buffered saline (PBS) are depicted in FIG. 2. The data points for storage modulus (G′), loss modulus (G″), and the complex viscosity (q*) are indicated by black dots, dark grey triangles, and light grey squares, respectively; the y axis is presented in logarithmic scale.

The storage modulus (G′) and loss modulus (G″) of a polymer sample may be used to quantitatively determine the gel point. Specifically, the gel point may be taken as the temperature at which the storage modulus, G′ first exceeds the loss modulus, G″.

The quantitatively determined gelation points correspond to those determined visually. For example, a polymer solution of P16 at 15 w/w % gels visually at 33° C., followed by a slight syneresis observed at 41° C., which progresses as the temperature increases until the polymer completely precipitates out of solution (two clear phases are observed). Gelation occurs at 35° C. according to the rheological measurements. This is in within experimental error of the visual observation. A maximum viscosity of 1986 Pa s is recorded at 42° C., which corresponds to the area of a cloudy gel visually observed (within the experimental error). As the system is heated up to 45° C., the loss modulus G″ becomes dominant, thus indicating that the liquid phase is prominent.

Those of skill in the art will recognize that the invention can be practiced in a variety of embodiments and that the foregoing description and examples are for purposes of illustration and not limitation of the claims that follow. The invention may be embodied in other specific forms without departing from the spirit or scope thereof. Changes that come within the meaning and range of equivalency of the claims are intended to be embraced therein.

1. A block copolymer comprising at least three polymer blocks, block A, block B and block C,
wherein block A comprises polymerised monomer A′ or polymerised monomers A′ and C′;
block B comprises polymerised monomer B′; and
block C comprises polymerised monomer C′ or polymerised monomers A′ and C′: 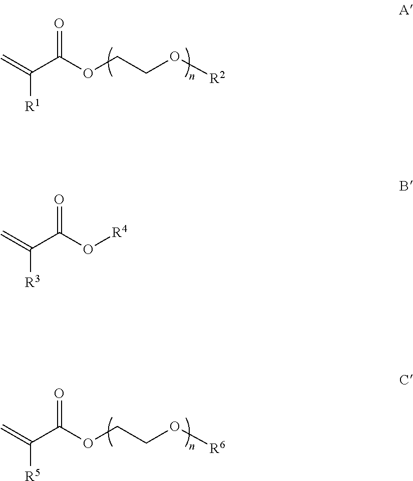
wherein each of R¹, R³, and R⁵ is independently selected from hydrogen and methyl;
each of R² and R⁶ is independently selected from hydrogen and C₁-C₃ alkyl;
R⁴ is C₁-C₁₄ alkyl; and
n is an integer of at least 3.

2. The block copolymer of claim 1, wherein R¹, R³, and/or R⁵ is methyl.

3. The block copolymer of claim 1, wherein R² and/or R⁶ is methyl.

4. The block copolymer of claim 1, wherein R⁴ is n-butyl.

5. The block copolymer of claim 1, wherein n is 3-12, optionally 3-7.

6. The block copolymer of claim 5, wherein n is 5.

7. The block copolymer of claim 1, wherein block A is a homopolymer of monomer A′ or a random copolymer of monomers A′ and C′; block B is a homopolymer of monomer B′; and block C is a homopolymer of monomer C′ or a random copolymer of monomers A′ and C′.

8. The block copolymer of claim 1, wherein block A is poly(penta(ethylene glycol) methyl ether methacrylate), block B is poly(n-butyl methacrylate), and block C is poly(di(ethylene glycol) methyl ether methacrylate).

9. The block copolymer of claim 1, comprising 10 mol % to 80 mol % of each of polymerised monomer A′, monomer B′ and monomer C′, as a proportion of the total polymerised monomer A′, monomer B′ and monomer C′ content of the block copolymer.

10. The block copolymer of claim 9, comprising about 15 mol % to about 40 mol % of polymerised monomer A′, about 35 mol % to about 55 mol % of polymerised monomer B′, and about 20 mol % to about 45 mol % of polymerised monomer C′, as a proportion of the total polymerised monomer A′, monomer B′ and monomer C′ content of the block copolymer.

11. The block copolymer of claim 1, comprising 10 w/w % to 80 w/w % of each of polymerised monomer A′, monomer B′ and monomer C′, as a proportion of the total polymerised monomer A′, monomer B′ and monomer C′ content of the block copolymer.

12. The block copolymer of claim 11, comprising about 30 to about 55 w/w % of polymerised monomer A′, about 25 to about 40 w/w % of polymerised monomer B′, and about 15 to about 40 w/w % of polymerised monomer C′ as a proportion of total polymerised monomer A′, monomer B′ and monomer C′.

13. The block copolymer of claim 1, wherein the block copolymer has a number average molar mass of about 1 to about 50 kDa, optionally about 5 to about 25 kDa.

14. The block copolymer of claim 1, wherein the block copolymer has a dispersity index (Ð) of 2.0 or less.

15. The block copolymer of claim 1, wherein each of blocks A, B, and C comprise at least 5 monomeric repeat units.

16. The block copolymer of claim 15, wherein block A consists of 5 to 20 monomeric repeat units, block B consists of 10 to 30 monomeric repeat units, and/or block C consists of 5 to 25 monomeric repeat units.

17. The block copolymer of claim 1, comprising three blocks A, B, and C arranged according to formula (I) or (II) or (III):
-A-B-C- (I)
-B-A-C- (II)
-A-C-B- (III).

18. The block copolymer of claim 1, wherein the block copolymer has a gelation point at a concentration of 30 w/w % and at a temperature of 20° C. or above.

19. A thermoresponsive gel composition comprising a block copolymer according to claim 1 and an aqueous solvent.

20. A method for preparing a block copolymer according to claim 1 by group transfer polymerisation, comprising the step of:
sequentially polymerising monomers A′, B′ and C′, in any order, in the presence of an initiator and a catalyst to form a block copolymer.

21. The method of claim 20, further comprising the step of isolating the formed block copolymer.

22. The method of claim 20, wherein the initiator is 1-methoxy-1-trimethylsiloxy-2-methyl propene (MTS) and the catalyst is tetrabutyl ammonium bibenzoate (TBABB).

23. The method of claim 20, wherein 10 mol % to 80 mol % of each of polymerised monomer A′, monomer B′ and monomer C′ are introduced into the polymerisation reaction as a proportion of the total monomer A′, monomer B′ and monomer C′ introduced.

24. The method of claim 20, about 15 mol % to about 40 mol % of polymerised monomer A′, about 35 mol % to about 55 mol % of polymerised monomer B′, and/or about 20 mol % to about 45 mol % of polymerised monomer C′ are introduced into the polymerisation reaction as a proportion of the total monomer A′, monomer B′ and monomer C′ introduced.
